(19) United States
(12) Patent Application Publication
(10) Pub. No.: US 2026/0089639 A1
(43) Pub. Date: Mar. 26, 2026

(54) LOW-POWER WAKEUP SIGNAL TIME GAP

(71) Applicant: QUALCOMM Incorporated, San Diego, CA (US)

(72) Inventors: Kazuki TAKEDA, Minato-ku (JP); Huilin XU, Beijing (CN); Changhwan PARK, San Diego, CA (US)

(21) Appl. No.: 19/277,232

(22) Filed: Jul. 22, 2025

Related U.S. Application Data
(60) Provisional application No. 63/698,486, filed on Sep. 24, 2024.

(51) Int. Cl. H04W 52/02; H04W 72/232

(52) U.S. Cl. CPC H04W 52/0235; H04W 72/232

(57) ABSTRACT

Methods, systems, and devices for wireless communications are described. A user equipment (UE) may receive a low-power wakeup signal (LP-WUS) that triggers physical downlink control channel (PDCCH) monitoring during a PDCCH monitoring period, wherein the LP-WUS is associated with a set of periodic LP-WUS transmissions scheduled during a corresponding set of periodic LP-WUS monitoring occasions. The UE may perform the PDCCH monitoring during the PDCCH monitoring period based at least in part on the LP-WUS, wherein monitoring for one or more additional LP-WUS transmissions during one or more other LP-WUS monitoring occasions in the corresponding set of periodic LP-WUS monitoring occasions that overlap in time with at least the PDCCH monitoring period is skipped.

### CROSS REFERENCES

The present application for patent claims benefit of U.S. Provisional Patent Application No. 63/698,486 by TAKEDA et al., entitled “LOW-POWER WAKEUP SIGNAL TIME GAP,” filed Sep. 24, 2024, assigned to the assignee hereof, and expressly incorporated herein.

### FIELD OF TECHNOLOGY

The following relates to wireless communications, including low-power wakeup signal time gap.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, using a first radio of the UE, a wakeup signal (WUS) that triggers physical downlink control channel (PDCCH) monitoring using a second radio of the UE during a PDCCH monitoring period, where the WUS is associated with a set of periodic WUS transmissions scheduled during a corresponding set of periodic WUS monitoring occasions and performing, using the second radio of the UE, the PDCCH monitoring during the PDCCH monitoring period based on the WUS, where monitoring for one or more additional WUS transmissions during one or more other WUS monitoring occasions in the corresponding set of periodic WUS monitoring occasions that overlap in time with at least the PDCCH monitoring period is skipped.

A UE for wireless communications is described. The UE may include one or more memories storing processor executable code, and one or more processors coupled with the one or more memories. The one or more processors may individually or collectively be operable to execute the code to cause the UE to receive, using a first radio of the UE, a WUS that triggers PDCCH monitoring using a second radio of the UE during a PDCCH monitoring period, where the WUS is associated with a set of periodic WUS transmissions scheduled during a corresponding set of periodic WUS monitoring occasions and perform, using the second radio of the UE, the PDCCH monitoring during the PDCCH monitoring period based on the WUS, where monitoring for one or more additional WUS transmissions during one or more other WUS monitoring occasions in the corresponding set of periodic WUS monitoring occasions that overlap in time with at least the PDCCH monitoring period is skipped.

Another UE for wireless communications is described. The UE may include means for receiving, using a first radio of the UE, a WUS that triggers PDCCH monitoring using a second radio of the UE during a PDCCH monitoring period, where the WUS is associated with a set of periodic WUS transmissions scheduled during a corresponding set of periodic WUS monitoring occasions and means for performing, using the second radio of the UE, the PDCCH monitoring during the PDCCH monitoring period based on the WUS, where monitoring for one or more additional WUS transmissions during one or more other WUS monitoring occasions in the corresponding set of periodic WUS monitoring occasions that overlap in time with at least the PDCCH monitoring period is skipped.

A non-transitory computer-readable medium storing code for wireless communications is described. The code may include instructions executable by one or more processors to receive, using a first radio of the UE, a WUS that triggers PDCCH monitoring using a second radio of the UE during a PDCCH monitoring period, where the WUS is associated with a set of periodic WUS transmissions scheduled during a corresponding set of periodic WUS monitoring occasions and perform, using the second radio of the UE, the PDCCH monitoring during the PDCCH monitoring period based on the WUS, where monitoring for one or more additional WUS transmissions during one or more other WUS monitoring occasions in the corresponding set of periodic WUS monitoring occasions that overlap in time with at least the PDCCH monitoring period is skipped.

In some examples of the method, user equipment (UEs), and non-transitory computer-readable medium described herein, the one or more other WUS monitoring occasions correspond to the PDCCH monitoring period.

Some examples of the method, user equipment (UEs), and non-transitory computer-readable medium described herein may further include operations, features, means, or instructions for skipping monitoring for one or more additional WUS transmissions during one or more WUS monitoring occasions in the corresponding set of periodic WUS monitoring occasions that overlap in time with a time period before the PDCCH monitoring period.

In some examples of the method, user equipment (UEs), and non-transitory computer-readable medium described herein, the time period corresponds to a time gap between the WUS transmission triggering the PDCCH monitoring and the PDCCH monitoring period.

In some examples of the method, user equipment (UEs), and non-transitory computer-readable medium described herein, the time period may be a same time period as a time gap between the PDCCH monitoring period and a start of a WUS monitoring occasion after the PDCCH monitoring period.

Some examples of the method, user equipment (UEs), and non-transitory computer-readable medium described herein may further include operations, features, means, or instructions for skipping monitoring for one or more additional WUS transmissions during one or more WUS monitoring occasions in the corresponding set of periodic WUS monitoring occasions that overlap in time with a time period following the PDCCH monitoring period.

In some examples of the method, user equipment (UEs), and non-transitory computer-readable medium described herein, the time period corresponds to a time gap between the PDCCH monitoring period and a start of a WUS monitoring occasion after the PDCCH monitoring period.

In some examples of the method, user equipment (UEs), and non-transitory computer-readable medium described herein, the time period may be a same time period as a time gap between the WUS transmission triggering the PDCCH monitoring and the PDCCH monitoring period.

Some examples of the method, user equipment (UEs), and non-transitory computer-readable medium described herein may further include operations, features, means, or instructions for transmitting a capability report indicating a defined time gap that corresponds to a time gap between the WUS transmission triggering the PDCCH monitoring and the PDCCH monitoring period, where the defined time gap may be based on whether WUS frequency resources of the set of periodic WUS transmissions overlap in frequency with an active bandwidth part associated with PDCCH monitoring frequency resources.

In some examples of the method, user equipment (UEs), and non-transitory computer-readable medium described herein, the capability report indicates a first defined time gap when the WUS frequency resources may be within the active bandwidth part, a second defined time gap when the WUS frequency resources may be outside of the active bandwidth part, or both.

In some examples of the method, user equipment (UEs), and non-transitory computer-readable medium described herein, the capability report indicates a first defined time gap when the WUS frequency resources may be within the active bandwidth part and an offset value relative to the first defined time gap when the WUS frequency resources may be outside of the active bandwidth part.

Some examples of the method, user equipment (UEs), and non-transitory computer-readable medium described herein may further include operations, features, means, or instructions for transmitting a capability report indicating a defined time gap that corresponds to a time gap between the PDCCH monitoring period and a start of a WUS monitoring occasion after the PDCCH monitoring period, where the defined time gap may be based on whether WUS frequency resources of the set of periodic WUS transmissions overlap in frequency with an active bandwidth part associated with PDCCH monitoring frequency resources.

In some examples of the method, user equipment (UEs), and non-transitory computer-readable medium described herein, the capability report indicates a first defined time gap when the WUS frequency resources may be within the active bandwidth part, a second defined time gap when the WUS frequency resources may be outside of the active bandwidth part, or both.

In some examples of the method, user equipment (UEs), and non-transitory computer-readable medium described herein, the capability report indicates a first defined time gap when the WUS frequency resources may be within the active bandwidth part and an offset value relative to the first defined time gap when the WUS frequency resources may be outside of the active bandwidth part.

In some examples of the method, user equipment (UEs), and non-transitory computer-readable medium described herein, the first radio includes a low-power radio of the UE and the second radio includes a main radio of the UE.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports low-power wakeup signal (LP-WUS) time gap in accordance with one or more aspects of the present disclosure.

FIG. 2 shows an example of a LP-WUS configuration that supports LP-WUS time gap in accordance with one or more aspects of the present disclosure.

FIG. 3 shows an example of a LP-WUS configuration that supports LP-WUS time gap in accordance with one or more aspects of the present disclosure.

FIG. 4 shows an example of a LP-WUS configuration that supports LP-WUS time gap in accordance with one or more aspects of the present disclosure.

FIGS. 5 and 6 show block diagrams of devices that support LP-WUS time gap in accordance with one or more aspects of the present disclosure.

FIG. 7 shows a block diagram of a communications manager that supports LP-WUS time gap in accordance with one or more aspects of the present disclosure.

FIG. 8 shows a diagram of a system including a device that supports LP-WUS time gap in accordance with one or more aspects of the present disclosure.

FIGS. 9 through 11 show flowcharts illustrating methods that support WUS time gap in accordance with one or more aspects of the present disclosure.

### DETAILED DESCRIPTION

Wireless networks may use low-power wakeup signal (LP-WUS) transmissions for energy savings at user equipment (UE). The UE may use a low-power radio (LR) to monitor for the LP-WUS transmissions to determine whether any LP-WUS transmissions have triggered the UE to perform physical downlink control channel (PDCCH) monitoring using a main radio (MR) of the UE. Once triggered, the UE may power up the MR and perform the PDCCH monitoring during a PDCCH monitoring occasion. However, the UE may continue to use the LR to monitor for LP-WUS transmissions during LP-WUS monitoring occasions that overlap with the PDCCH monitoring occasion.

Accordingly, aspects of the techniques described herein provide for the UE to not use the LR to monitor LP-WUS transmissions during LP-WUS monitoring occasions that overlap with the PDCCH monitoring period, as well as before, after, or both, the PDCCH monitoring period. For example, the UE may use a first radio (e.g., the LR) to receive a LP-WUS that triggers PDCCH monitoring using a second radio (e.g., the MR) of the UE during the PDCCH monitoring period. The LP-WUS may be associated with a set of periodic LP-WUS monitoring occasions. The UE may use the second radio to perform the PDCCH monitoring during the PDCCH monitoring period in response to the LP-WUS. However, the UE may skip monitoring for additional LP-WUS transmission(s) during corresponding LP-WUS monitoring occasions that overlap (e.g., in the time domain) with at least the PDCCH monitoring period. The techniques discussed herein generally apply to WUSs, where an LP-WUS may be an example of a WUS.

Aspects of the disclosure are initially described in the context of wireless communications systems. Aspects of the disclosure are further illustrated by and described with reference to apparatus diagrams, system diagrams, and flowcharts that relate to LP-WUS time gap.

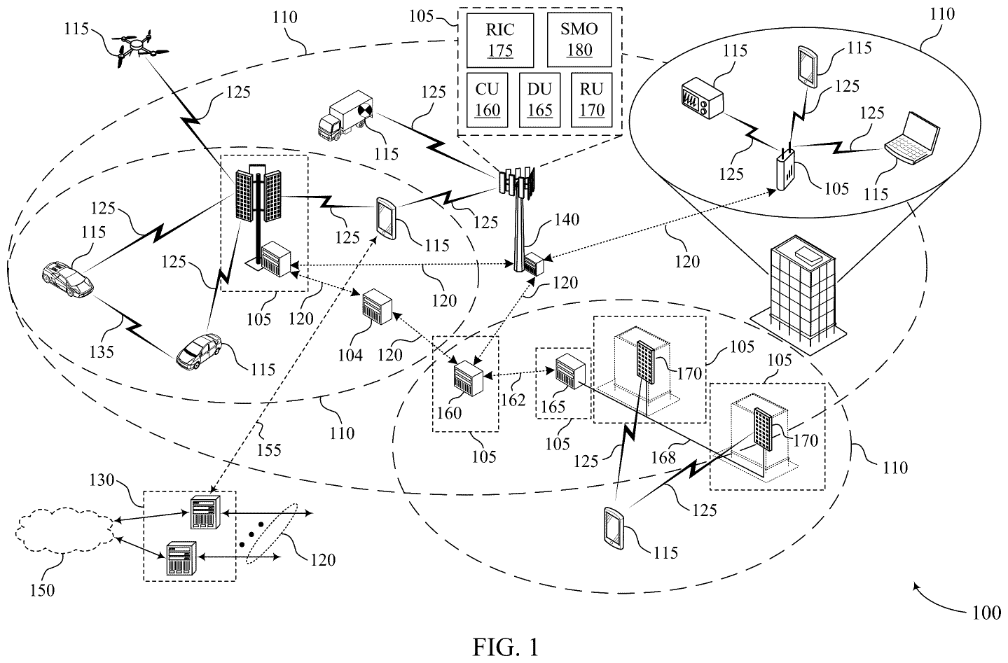

FIG. 1 shows an example of a wireless communications system 100 that supports LP-WUS time gap in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support LP-WUS time gap as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may receive, using a first radio of the UE 115, a LP-WUS that triggers PDCCH monitoring using a second radio of the UE 115 during a PDCCH monitoring period, wherein the LP-WUS is associated with a set of periodic LP-WUS transmissions scheduled during a corresponding set of periodic LP-WUS monitoring occasions. The UE 115 may perform, using the second radio of the UE, the PDCCH monitoring during the PDCCH monitoring period based at least in part on the LP-WUS, wherein monitoring for one or more additional LP-WUS transmissions during one or more other LP-WUS monitoring occasions in the corresponding set of periodic LP-WUS monitoring occasions that overlap in time with at least the PDCCH monitoring period is skipped.

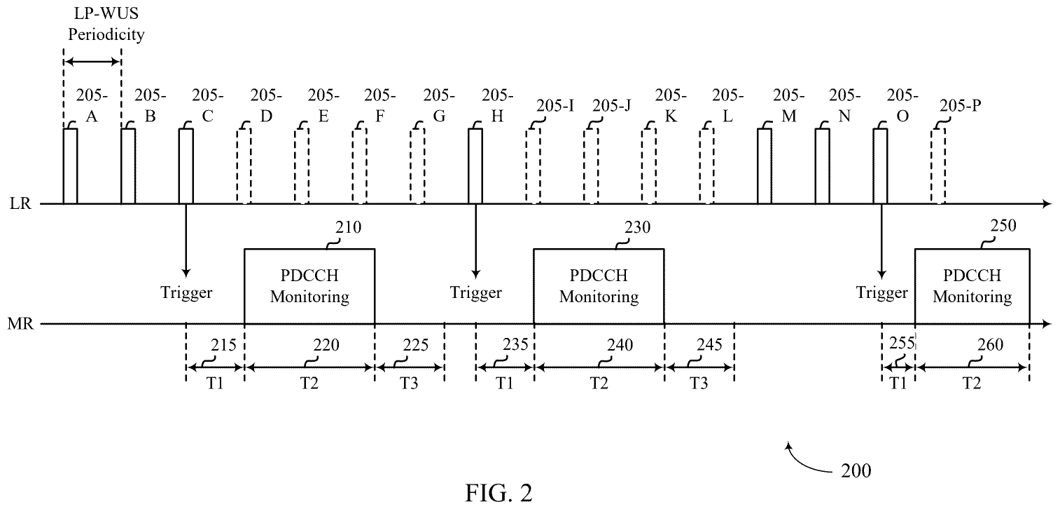

FIG. 2 shows an example of a LP-WUS configuration 200 that supports LP-WUS time gap in accordance with one or more aspects of the present disclosure. LP-WUS configuration 200 may implement aspects of or be implemented by aspects of wireless communications system 100. For example, various aspects of LP-WUS configuration 200 may be implemented by a UE or a network entity, which may be examples of the corresponding devices described herein.

Wireless networks may support a UE operating in an RRC connected mode such that a procedure is provided to allow the UE to use its MR for PDCCH monitoring triggered by a LP-WUS. For example, the LP-WUS may be used for an activation or deactivation procedure for the LP-WUS monitoring by the UE. This may include the UE performing various radio resource management (RRM), radio link management (RLM), beam failure detection (BFD), or channel state information (CSI) measurements using the MR. In some aspects, such networks may optimize the LP-WUS design for UEs operating in an RRC idle or RRC inactive mode over such optimizations for the connected mode UE.

More particularly, the LP-WUS operations when the UE is in the RRC connected mode may include the UE monitoring for LP-WUS using a LR during or on LP-WUS monitoring occasions that are RRC configured for the UE. If the UE detects a LP-WUS that triggers PDCCH monitoring, the UE may use the MR to start PDCCH monitoring after a certain time duration. That is, there may be a time gap between the LP-WUS that triggers the active PDCCH monitoring using the MR and when the UE actually begins PDCCH monitoring. For example, the time gap may correspond to the time period it takes the UE to process the LP-WUS that triggered the PDCCH monitoring and then to wake up the MR of the UE to perform the PDCCH monitoring.

For such connected mode UEs, different procedures may be used to trigger such PDCCH monitoring. A first case may include the PDCCH monitoring being triggered by LP-WUS configured with a connected mode discontinuous reception (C-DRX) configuration of the UE (e.g., the LP-WUS monitoring occasions are aligned, at least somewhat, with the UE's C-DRX operations of the UE). One option of this case may include the LP-WUS monitoring according to the LP-WUS monitoring configuration before the DRX ON duration to trigger the start of the DRX ON duration. This first option may be adopted as a baseline approach that is enabled similar to previous techniques (e.g., such as a downlink control information (DCI) with the cyclic redundancy check (CRC) scrambled by the power saving-radio network temporary identifier (PS-RNTI)). The UE monitors LP-WUS in a LP-WUS monitoring occasion/window for a DRX ON time in each DRX cycle at least a minimum gap before the slot that the DRX ON duration timer would start and the LP-WUS may inform the UE whether the UE shall monitor PDCCH in the DRX active time of the DRX cycle. The UE may be configured with PDCCH skipping or search space set group (SSSG) switching. The PDCCH monitoring in the DRX active time, even if triggered by the LP-WUS, can be skipped/reduced by the PDCCH skipping or SSSG switching indication. This may be used for power savings, such as when the values of the DRX ON duration timer or the DRX inactivity timer are relatively large.

A second option of this case may include the LP-WUS monitoring being outside of the legacy C-DRX active time according to the LP-WUS monitoring configuration to trigger the PDCCH monitoring. That is, in this second option the PDCCH monitoring may be triggered irrespective of the DRX ON duration timer. The LP-WUS monitoring outside of at least the legacy C-DRX active time may be according to the LP-WUS monitoring configuration to trigger the PDCCH monitoring. The UE may be configured with the C-DRX configuration and with the LP-WUS monitoring configuration (e.g., such as the periodicity and offset which may be different from those in the C-DRX configuration). The LP-WUS may trigger the start of a timer during which the UE monitoring PDCCH and the UE PDCCH monitoring behavior may not be affected by other timers (e.g., such as the DRX inactivity timer, the DRX retransmission timer for downlink, the DRX retransmission timer for uplink, the DRX HARQ round trip time (RTT) timer for downlink or the DRX HARQ RTT for uplink. In some aspects, the UE PDCCH monitoring may not be triggered by the legacy C-DRX cycle and DRX ON duration timer when monitoring the LP-WUS.

This second option may be based on two sub-options adopted in some wireless networks. The first sub-option may include the PDCCH monitoring being additionally triggered based on the legacy C-DRX cycle and the DRX ON duration timer when monitoring the LP-WUS. The second sub-option may include the PDCCH monitoring not being triggered by the legacy C-DRX cycle and the DRX ON duration timer when monitoring the LP-WUS. A third option that may be adopted may include the LP-WUS monitoring inside at least the legacy C-DRX active time according to the LP-WUS monitoring configuration to trigger the PDCCH monitoring.

In some aspects, the UE may use capability reporting for determination of the minimum gap time between the LP-WUS reception and the MR being used to start PDCCH monitoring. In one alternative for the RRC connected mode UE, the UE may report one value for each SCS from X candidate values for the determination of the minimum time gap between the LP-WUS reception and the MR to start PDCCH monitoring via the UE capability reporting. In another alternative for the RRC connected mode UE, the UE may report multiple values for each SCS from X candidate values for the determination of the minimum time gap between the LP-WUS reception and MR to start PDCCH monitoring via the UE capability report.

Accordingly, the LP-WUS being used to trigger the PDCCH monitoring for a UE and, due to the processing and wakeup time for the MR, the minimum time gap between the LP-WUS triggering the PDCCH monitoring and the start of the triggered PDCCH may be used. Moreover, such networks may support UE capability reporting of the minimum necessary time gap (e.g., how much time gap is necessary to wake up the MR based on the LP-WUS). However, such networks are incomplete or inefficient in such details regarding the minimum necessary time gap.

Accordingly, aspects of the techniques described herein provide additional details and features regarding a defined time gap (e.g., the minimum necessary time gap) associated with LP-WUS-based triggering of PDCCH monitoring. Moreover, such techniques improve efficiency of the UE operations by skipping various LP-WUS monitoring occasions once the UE has been triggered to perform PDCCH monitoring by a LP-WUS.

For example, the UE may receive or otherwise obtain a signal that configures the UE to monitor for LP-WUS during a set of period LP-WUS monitoring occasions. The signal may include RRC signaling or other signaling means that carry or otherwise convey an indication of a LP-WUS configuration to be applied by the UE. The set of periodic LP-WUS monitoring occasions are illustrated by way of example only in FIG. 2 as the set including multiple instances of the LP-WUS monitoring occasion 205. For example, the set of periodic LP-WUS monitoring occasions may include LP-WUS monitoring occasion 205-a through LP-WUS monitoring occasion 205-p, in this non-limiting example. The UE may therefore use a first radio of the UE (e.g., the LR) to monitor for LP-WUS during each LP-WUS monitoring occasion 205.

The UE may use the first radio to receive or otherwise obtain a LP-WUS that triggers PDCCH monitoring using a second radio of the UE during a PDCCH monitoring period. FIG. 2 illustrates three examples of a LP-WUS being used to trigger PDCCH monitoring for the UE. In each instance, the UE may use the second radio to perform the PDCCH monitoring during the PDCCH monitoring period based on the LP-WUS. However, the UE may skip monitoring for additional LP-WUS transmissions during one or more of the LP-WUS monitoring occasion 205 in the corresponding set of periodic LP-WUS monitoring occasions that overlap in time with at least the PDCCH monitoring period.

That is, aspects of the techniques described herein provide for one, some, or all of time periods T1, T2, and T3 being defined that relate to the LP-WUS-triggered PDCCH monitoring by the UE. The UE may not monitor for LP-WUS transmissions on the configured LP-WUS monitoring occasion(s) in or during the time periods T1, T2, and/or T3. The time period T1 may generally correspond to the time gap after the LP-WUS that triggered the PDCCH monitoring and the start of the triggered PDCCH monitoring. For example, the UE may skip monitoring for additional LP-WUS transmissions during LP-WUS monitoring occasion(s) in that overlap with a time period before the PDCCH monitoring. That is, the T1 time period may correspond to the time gap between the LP-WUS transmission that triggered the PDCCH monitoring and the PDCCH monitoring period. In some aspects, the T1 time period may correspond to the same time period as a time gap between the PDCCH monitoring period and a start of a LP-WUS monitoring occasion after the PDCCH monitoring period (e.g., the T3 time period). In other examples, the T1 time period and the T3 time period may be different time periods (e.g., have different durations).

The time period T2 may generally correspond to the time window during which the UE monitors for the PDCCH. That is, the T2 time period where the UE skips monitoring for LP-WUS transmissions during corresponding LP-WUS monitoring occasions may correspond to or be the same as the PDCCH monitoring period.

The time period T3 may generally correspond to the time gap after the UE ends the PDCCH monitoring in the window and until the start of the LP-WUS monitoring occasion. For example, the UE may skip monitoring for LP-WUS transmission(s) during corresponding LP-WUS monitoring occasion(s) that overlap in time with a time period following the PDCCH monitoring period. That is, the T3 time period may correspond to a time gap between the PDCCH monitoring period and a start of a LP-WUS monitoring occasion 205 after the PDCCH monitoring period. In some aspects, the T3 time period may be a same time period as a time gap between the LP-WUS transmission that triggers the PDCCH monitoring and the PDCCH monitoring period (e.g., the T1 time period). In other examples, the T1 time period and the T3 time period may be different time periods (e.g., have different durations).

In some aspects, the end of the time period that the UE monitors PDCCH (e.g., the end of the T2 time period and the beginning of the T3 time period) may be determined according to various techniques. As one example, this may include the end of the T2 time period and the beginning of the T3 time period being based on a timer not running (e.g., the timer has expired) or no timers from a set of timers running are running. Examples of such timers include, but are not limited to, the DRX ON duration timer, the DRX inactivity timer, the DRX retransmission timers for downlink or uplink, or the random-access (RA) contention resolution timer, or any combination thereof. Expiration of one or more such timer(s) may be used as a trigger to transition from the T2 time period to the T3 time period. In another example, the transition may be based on no pending scheduling request (SR) at the UE. For example, the timer may correspond to a SR prohibit timer running.

As discussed above, in some examples the duration of T3 time period may be equal to the duration of the T1 time period. For example, both time periods may be based on the ramp-up time (e.g., for the T1 time period) of the MR of the UE, the ramp-down time (e.g., for the T3 time period) of the MR of the UE, or both. However, in other examples the ramp-up time and the ramp-down time of the MR may be different such that the T1 time period and the T3 time period may have different durations. In some aspects, the UE capability reporting may include the UE reporting separate T1 and T3 time period indications.

As shown in FIG. 2, this may include the UE using the first radio (e.g., the LR) to monitor for LP-WUS transmissions during the LP-WUS monitoring occasion 205-a, the LP-WUS monitoring occasion 205-b, and the LP-WUS monitoring occasion 205-c. In this example, the LP-WUS monitoring occasion 205-c may carry or otherwise convey an indication or information that triggers PDCCH monitoring for the UE using the second radio (e.g., the MR). Accordingly, the UE may perform PDCCH monitoring during the PDCCH monitoring period 210 according to the LP-WUS monitoring occasion 205-c being a triggering LP-WUS.

The UE may skip monitoring for additional LP-WUS transmission(s) at least during LP-WUS monitoring occasions that overlap in the time domain with the PDCCH monitoring period 210. The UE may skip monitoring for additional LP-WUS transmissions during the LP-WUS monitoring occasion 205-d, during the LP-WUS monitoring occasion 205-e, and during the LP-WUS monitoring occasion 205-f that overlap in the time domain with the PDCCH monitoring period 210 (e.g., corresponding to the T2 time period 220).

Additionally, or alternatively, this may include the UE skipping monitoring for additional LP-WUS transmissions during the T1 time period 215 that includes LP-WUS monitoring occasions that occur between the LP-WUS monitoring occasion 205-c and the beginning of the PDCCH monitoring period 210 where the UE monitors the PDCCH. Additionally, or alternatively, this may include the UE skipping monitoring for additional LP-WUS transmissions during the T3 time period 225 that includes LP-WUS monitoring occasions that occur after the PDCCH monitoring period 210 and before a start or beginning of a next or subsequent LP-WUS monitoring occasion 205. In this example, this may include the UE skipping monitoring for the additional LP-WUS transmissions during the LP-WUS monitoring occasion 205-g.

This may include the UE using the first radio (e.g., the LR) to monitor for LP-WUS transmissions during the LP-WUS monitoring occasion 205-h (e.g., the first LP-WUS monitoring occasion after the end of the T3 time period 225). In this example, the LP-WUS monitoring occasion 205-h may carry or otherwise convey an indication or information that triggers PDCCH monitoring for the UE using the second radio (e.g., the MR). Accordingly, the UE may perform PDCCH monitoring during the PDCCH monitoring period 230 according to the LP-WUS monitoring occasion 205-h being a triggering LP-WUS.

The UE may skip monitoring for additional LP-WUS transmission(s) at least during LP-WUS monitoring occasions that overlap in the time domain with the PDCCH monitoring period 230. The UE may skip monitoring for additional LP-WUS transmissions during the LP-WUS monitoring occasion 205-i, during the LP-WUS monitoring occasion 205-j, and during the LP-WUS monitoring occasion 205-k that overlap in the time domain with the PDCCH monitoring period 230 (e.g., corresponding to the T2 time period 240).

Additionally, or alternatively, this may include the UE skipping monitoring for additional LP-WUS transmissions during the T1 time period 235 that includes LP-WUS monitoring occasions that occur between the LP-WUS monitoring occasion 205-h and the beginning of the PDCCH monitoring period 230 where the UE monitors the PDCCH. Additionally, or alternatively, this may include the UE skipping monitoring for additional LP-WUS transmissions during the T3 time period 245 that includes LP-WUS monitoring occasions that occur after the PDCCH monitoring period 230 and before a start or beginning of a next or subsequent LP-WUS monitoring occasion 205. In this example, this may include the UE skipping monitoring for the additional LP-WUS transmissions during the LP-WUS monitoring occasion 205-1.

This may include the UE using the first radio (e.g., the LR) to monitor for LP-WUS transmissions during the LP-WUS monitoring occasion 205-m (e.g., the first LP-WUS monitoring occasion after the end of the T3 time period 245), during the LP-WUS monitoring occasion 205-n, and during the LP-WUS monitoring occasion 205-o. In this example, the LP-WUS monitoring occasion 205-o may carry or otherwise convey an indication or information that triggers PDCCH monitoring for the UE using the second radio (e.g., the MR). Accordingly, the UE may perform PDCCH monitoring during the PDCCH monitoring period 250 according to the LP-WUS monitoring occasion 205-o being a triggering LP-WUS.

The UE may skip monitoring for additional LP-WUS transmission(s) at least during LP-WUS monitoring occasions that overlap in the time domain with the PDCCH monitoring period 250. The UE may skip monitoring for additional LP-WUS transmissions during the LP-WUS monitoring occasion 205-p and subsequent LP-WUS monitoring occasion(s) that overlap in the time domain with the PDCCH monitoring period 250 (e.g., corresponding to the T2 time period 260).

Additionally, or alternatively, this may include the UE skipping monitoring for additional LP-WUS transmissions during the T1 time period 255 that includes LP-WUS monitoring occasions that occur between the LP-WUS monitoring occasion 205-o and the beginning of the PDCCH monitoring period 250 where the UE monitors the PDCCH. Additionally, or alternatively, this may include the UE skipping monitoring for additional LP-WUS transmissions during the T3 time period that includes LP-WUS monitoring occasions that occur after the PDCCH monitoring period 250 and before a start or beginning of a next or subsequent LP-WUS monitoring occasion.

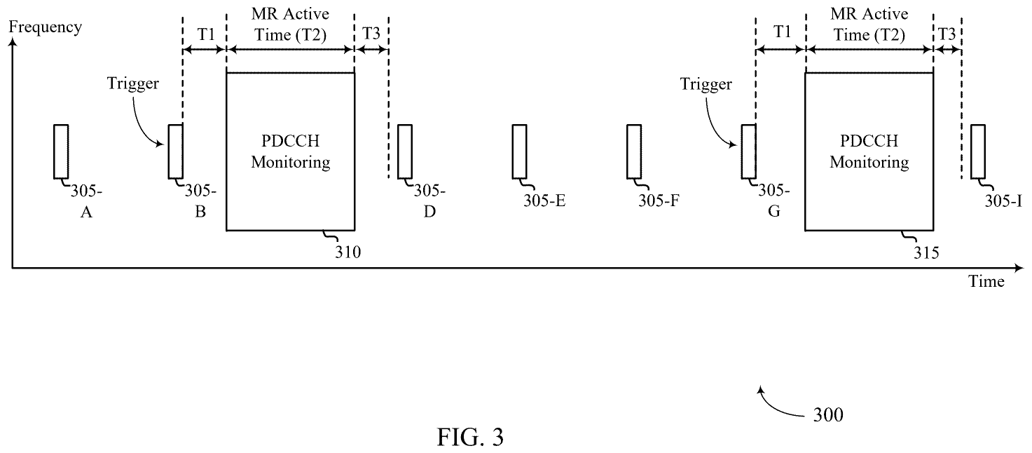

FIG. 3 shows an example of an LP-WUS configuration 300 that supports LP-WUS time gap in accordance with one or more aspects of the present disclosure. LP-WUS configuration 300 may implement aspects of or be implemented by aspects of wireless communications system 100 or LP-WUS configuration 200. For example, various aspects of LP-WUS configuration 300 may be implemented by a UE or a network entity, which may be examples of the corresponding devices described herein.

As discussed above, aspects of the techniques described herein provide additional details and features regarding the minimum necessary time gap associated with LP-WUS-based triggering of PDCCH monitoring. Moreover, such techniques improve efficiency of the UE operations by skipping various LP-WUS monitoring occasions once the UE has been triggered to perform PDCCH monitoring by a LP-WUS.

For example, the UE may receive or otherwise obtain a signal that configures the UE to monitor for LP-WUS during a set of period LP-WUS monitoring occasions. The signal may include RRC signaling or other signaling means that carry or otherwise convey an indication of a LP-WUS configuration to be applied by the UE. The set of periodic LP-WUS monitoring occasions are illustrated by way of example only in FIG. 3 as the set including multiple instances of the LP-WUS monitoring occasion 305. For example, the set of periodic LP-WUS monitoring occasions may include LP-WUS monitoring occasion 305-a through LP-WUS monitoring occasion 305-i. The UE may therefore use a first radio of the UE (e.g., the LR) to monitor for LP-WUS transmissions during each LP-WUS monitoring occasion 305.

The UE may use the first radio to receive or otherwise obtain a LP-WUS that triggers PDCCH monitoring using a second radio of the UE during a PDCCH monitoring period. FIG. 3 illustrates two examples of a LP-WUS being used to trigger PDCCH monitoring for the UE. In each instance, the UE may use the second radio to perform the PDCCH monitoring during the PDCCH monitoring period based on the LP-WUS. However, the UE may skip monitoring for additional LP-WUS transmissions during one or more of the LP-WUS monitoring occasion 305 in the corresponding set of periodic LP-WUS monitoring occasions that overlap in time with at least the PDCCH monitoring period.

That is, aspects of the techniques described herein provide for one, some, or all of time periods T1, T2, and T3 being defined that relate to the LP-WUS-triggered PDCCH monitoring by the UE. The UE may not monitor for LP-WUS transmissions on the configured LP-WUS monitoring occasion(s) in or during the time periods T1, T2, and/or T3.

As discussed, the minimum time gap (e.g., the T1 time period) may be until the beginning of the PDCCH monitoring window (e.g., the PDCCH monitoring period, which corresponds to the T2 time period) and, in some examples, the additional minimum time gap (e.g., the T3 time period) after the end of the PDCCH monitoring window. These time period(s) may correspond at least in part to the durations it takes the MR of the UE to wake up or go to sleep. In some aspects, the UE may support or otherwise operate in different levels of sleep (e.g., inactive, idle, light sleep, a deep sleep mode) and therefore the UE may report its minimum time gap(s) (e.g., any of T1, T2, or T3 time periods) for the different levels of sleep in its UE capability report.

In some cases, the MR wake up or sleep state transition may be associated with a bandwidth configuration change. For example, in some aspects part of the waking up or powering down process of the MR associated with PDCCH monitoring may include retuning the MR from one frequency or bandwidth or a second frequency or bandwidth. For example, in some cases the MR and the LR of the UE may share various radio frequency (RF) component(s) and some baseband (BB) components such that the bandwidth may not be fully independent. If the LP-WUS resource is within the active BWP (e.g., the frequency resource(s) or bandwidth) used for PDCCH monitoring that the LP-WUS triggers, the necessary time gap (e.g., the T1 time period and, in some cases, the T3 time period) may be different than when the LP-WUS resource is not within the active BWP. For example, if the LP-WUS resource is outside of the active BWP being used for PDCCH monitoring that the LP-WUS triggers, the UE may have to switch the frequency from the LP-WUS monitoring frequency to the PDCCH monitoring frequency (e.g., in additional to waking up or powering down the MR component(s)). For example, the wakeup and powering down process of the MR may take longer when the LP-WUS frequency resources are outside of the active BWP used for the PDCCH monitoring.

Accordingly, aspects of the techniques described herein additionally, or alternatively, may include the UE transmitting or otherwise outputting a capability report that carries or otherwise conveys an indication or information for a defined time gap that corresponds to a time gap between the LP-WUS transmission that triggers the PDCCH monitoring and the PDCCH monitoring period (e.g., the T1 time period). In some cases, the defined time gap (e.g., the T1 time period) may be based on whether the LP-WUS frequency resources of overlap in the frequency domain with an active BWP associated with PDCCH monitoring frequency resources.

Additionally, or alternatively, this may include the UE transmitting or otherwise outputting a capability report that carries or otherwise conveys an indication or information for a defined time gap that corresponds to a time gap between the PDCCH monitoring period and a start of a LP-WUS monitoring occasion after the PDCCH monitoring period (e.g., the T3 time period). Again, the defined time gap (e.g., the T3 time period) may be based on whether the LP-WUS frequency resources of overlap in the frequency domain with an active BWP associated with PDCCH monitoring frequency resources.

Thus, the UE may report its minimum necessary time gap for the T1 time period (and, additionally, or alternatively, the T3 time period) as part of its UE capability reporting. The UE capability reporting in this context may be based on when or whether the LP-WUS frequency resource(s) are within the active BWP being used for the PDCCH monitoring that the LP-WUS triggers.

In some cases, the UE may also report its minimum necessary time gap for T1′ (and, additionally, or alternatively, the T3′ time period) as part of its UE capability reporting. These indication(s) may be based on when or whether the LP-WUS frequency resource(s) are outside of the active BWP being used for the PDCCH monitoring that the LP-WUS triggers. That is, the capability report may indicate a first defined time gap when the LP-WUS frequency resource(s) are within the active BWP and, additionally, or alternatively, a second defined time gap when the LP-WUS frequency resource(s) are outside of the active BWP. The value(s) of T1′ (and potentially T3′) may be based on when the LP-WUS frequency resources are outside the active BWP used for PDCCH monitoring that the LP-WUS triggers. These values may be different from the value(s) of T1 (and potentially T3) when the LP-WUS frequency resource(s) are within the active BWP used for PDCCH monitoring that the LP-WUS triggers. If the UE does not report the value(s) of T1′ (and potentially T3′) when the LP-WUS frequency resources are outside the active BWP used for PDCCH monitoring that the LP-WUS triggers, the value(s) of T1′ (and potentially T3′) when the LP-WUS frequency resources are outside of the active BWP may be the same as the values of T1 (and potentially T3) when the LP-WUS frequency resource(s) are within the active BWP.

In some cases, the UE may also report its minimum necessary time gap for T1′ (and, additionally, or alternatively, the T3′ time period) as part of its UE capability reporting. These indication(s) may be based on when or whether the LP-WUS frequency resource(s) are outside of the active BWP being used for the PDCCH monitoring that the LP-WUS triggers. That is, the capability report may indicate a first defined time gap when the LP-WUS frequency resources are within the active BWP and an offset value relative to the first defined time gap when the LP-WUS frequency resources are outside of the active BWP. When the LP-WUS frequency resources are outside of the active BWP, the minimum necessary time gap T1′ may correspond to the above-reported T1 time period plus the offset X. Similarly, the T3′ may correspond to the above-reported T3 time period plus the offset X. In this aspect, the offset X may be the active BWP switch delay based on the DCI or a timer that are specified for the UE.

For example, the BWP switch delay may correspond to or be based on Table 1 below:

TABLE 1

| | |
|---|---|
| | BWP Switching Delay T_{BWPswitchDelay} |
| NR Slot | (Slots) |

| μ | Length (ms) | Type 1 (Note 1) | Type 2 (Note 2) |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

(Note 1):
Depends on UE Capability.
(Note 2):
If the BWP switch involves changing SCS, the BWP switch delay may be determined by the smaller SCS between the SCS before the BWP switch and the SCS after the BWP switch.

FIG. 3 illustrates an example where the frequency resource(s) of the LP-WUS are within the active BWP being used for the PDCCH monitoring. Accordingly, this may include the UE using the first radio (e.g., the LR) to monitor for LP-WUS transmissions during the LP-WUS monitoring occasion 305-a and the LP-WUS monitoring occasion 305-b. In this example, the LP-WUS monitoring occasion 305-b may carry or otherwise convey an indication or information that triggers PDCCH monitoring for the UE using the second radio (e.g., the MR). Accordingly, the UE may perform PDCCH monitoring during the PDCCH monitoring period 310 according to the LP-WUS monitoring occasion 305-b being a triggering LP-WUS.

The UE may skip monitoring for additional LP-WUS transmission(s) at least during LP-WUS monitoring occasions that overlap in the time domain with the PDCCH monitoring period 310. The UE may skip monitoring for additional LP-WUS transmissions during the LP-WUS monitoring occasion 305-c (not shown) that overlaps in the time domain with the PDCCH monitoring period 310 (e.g., corresponding to the T2 time period). Additionally, or alternatively, this may include the UE skipping monitoring for additional LP-WUS transmissions during the T1 time period that includes LP-WUS monitoring occasions that occur between the LP-WUS monitoring occasion 305-b and the beginning of the PDCCH monitoring period 310 where the UE monitors the PDCCH. Additionally, or alternatively, this may include the UE skipping monitoring for additional LP-WUS transmissions during the T3 time period that includes LP-WUS monitoring occasions that occur after the PDCCH monitoring period 310 and before a start or beginning of a next or subsequent LP-WUS monitoring occasion 305.

This may include the UE using the first radio (e.g., the LR) to monitor for LP-WUS transmissions during the LP-WUS monitoring occasion 305-d (e.g., the first LP-WUS monitoring occasion after the end of the T3 time period), during the LP-WUS monitoring occasion 305-e, during the LP-WUS monitoring occasion 305-f, and during the LP-WUS monitoring occasion 305-g. In this example, the LP-WUS monitoring occasion 305-g may carry or otherwise convey an indication or information that triggers PDCCH monitoring for the UE using the second radio (e.g., the MR). Accordingly, the UE may perform PDCCH monitoring during the PDCCH monitoring period 315 according to the LP-WUS monitoring occasion 305-g being a triggering LP-WUS. The UE may skip monitoring for additional LP-WUS transmission(s) at least during LP-WUS monitoring occasions that overlap in the time domain with the PDCCH monitoring period 315. The UE may skip monitoring for additional LP-WUS transmissions during the LP-WUS monitoring occasion 305-h (not shown) that overlaps in the time domain with the PDCCH monitoring period 315 (e.g., corresponding to the T2 time period). Additionally, or alternatively, this may include the UE skipping monitoring for additional LP-WUS transmissions during the T1 time period that includes LP-WUS monitoring occasions that occur between the LP-WUS monitoring occasion 305-g and the beginning of the PDCCH monitoring period 315 where the UE monitors the PDCCH. Additionally, or alternatively, this may include the UE skipping monitoring for additional LP-WUS transmissions during the T3 time period that includes LP-WUS monitoring occasions that occur after the PDCCH monitoring period 315 and before a start or beginning of a next or subsequent LP-WUS monitoring occasion 305. In this example, this may include the UE monitoring for additional LP-WUS transmissions during the LP-WUS monitoring occasion 305-i (e.g., after the T3 time period).

As the LP-WUS frequency resources are within the active BWP being used for the PDCCH monitoring, the duration of the T1 time period (and potentially the T3 time period) may be shorter relative to when the LP-WUS frequency resources are outside of the active BWP.

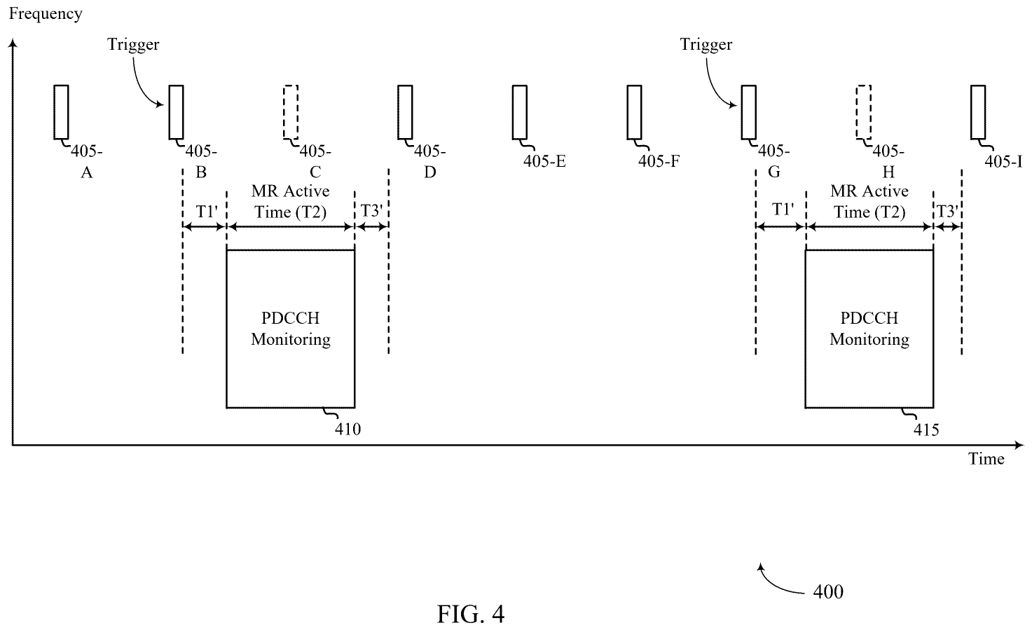

FIG. 4 shows an example of a LP-WUS configuration 400 that supports LP-WUS time gap in accordance with one or more aspects of the present disclosure. LP-WUS configuration 400 may implement aspects of or be implemented by aspects of wireless communications system 100, or aspects of LP-WUS configuration 200 or LP-WUS configuration 300. For example, various aspects of LP-WUS configuration 400 may be implemented by a UE or a network entity, which may be examples of the corresponding devices described herein.

As discussed above, aspects of the techniques described herein provide additional details and features regarding the minimum necessary time gap associated with LP-WUS-based triggering of PDCCH monitoring. Moreover, such techniques improve efficiency of the UE operations by skipping various LP-WUS monitoring occasions once the UE has been triggered to perform PDCCH monitoring by a LP-WUS.

For example, the UE may receive or otherwise obtain a signal that configures the UE to monitor for LP-WUS during a set of period LP-WUS monitoring occasions. The signal may include RRC signaling or other signaling means that carry or otherwise convey an indication of a LP-WUS configuration to be applied by the UE. The set of periodic LP-WUS monitoring occasions are illustrated by way of example only in FIG. 4 as the set including multiple instances of the LP-WUS monitoring occasion 405. For example, the set of periodic LP-WUS monitoring occasions may include LP-WUS monitoring occasion 405-a through LP-WUS monitoring occasion 405-i. The UE may therefore use a first radio of the UE (e.g., the LR) to monitor for LP-WUS transmissions during each LP-WUS monitoring occasion 405.

The UE may use the first radio to receive or otherwise obtain a LP-WUS that triggers PDCCH monitoring using a second radio of the UE during a PDCCH monitoring period. FIG. 4 illustrates two examples of a LP-WUS being used to trigger PDCCH monitoring for the UE. In each instance, the UE may use the second radio to perform the PDCCH monitoring during the PDCCH monitoring period based on the LP-WUS. However, the UE may skip monitoring for additional LP-WUS transmissions during one or more of the LP-WUS monitoring occasion 405 in the corresponding set of periodic LP-WUS monitoring occasions that overlap in time with at least the PDCCH monitoring period.

That is, aspects of the techniques described herein provide for one, some, or all of time periods T1, T2, and T3 being defined that relate to the LP-WUS-triggered PDCCH monitoring by the UE. The UE may not monitor for LP-WUS transmissions on the configured LP-WUS monitoring occasion(s) in or during the time periods T1, T2, and/or T3.

As discussed, the minimum time gap (e.g., the T1 time period) may be until the beginning of the PDCCH monitoring window (e.g., the PDCCH monitoring period, which corresponds to the T2 time period) and, in some examples, the additional minimum time gap (e.g., the T3 time period) after the end of the PDCCH monitoring window. These time period(s) may correspond at least in part to the durations it takes the MR of the UE to wake up or go to sleep. In some aspects, the UE may support or otherwise operate in different levels of sleep (e.g., inactive, idle, or a deep sleep mode) and therefore the UE may report its minimum time gap(s) (e.g., any of T1, T2, or T3 time periods) for the different levels of sleep in its UE capability report.

Aspects of the techniques described herein additionally, or alternatively, may include the UE transmitting or otherwise outputting a capability report that carries or otherwise conveys an indication or information for a defined time gap that corresponds to a time gap between the LP-WUS transmission that triggers the PDCCH monitoring and the PDCCH monitoring period (e.g., the T1 time period). In some cases, the defined time gap (e.g., the T1 time period) may be based on whether the LP-WUS frequency resources of overlap in the frequency domain with an active BWP associated with PDCCH monitoring frequency resources.

Additionally, or alternatively, this may include the UE transmitting or otherwise outputting a capability report that carries or otherwise conveys an indication or information for a defined time gap that corresponds to a time gap between the PDCCH monitoring period and a start of a LP-WUS monitoring occasion after the PDCCH monitoring period (e.g., the T3 time period). Again, the defined time gap (e.g., the T3 time period) may be based on whether the LP-WUS frequency resources of overlap in the frequency domain with an active BWP associated with PDCCH monitoring frequency resources.

Thus, the UE may report its minimum necessary time gap for the T1 time period (and, additionally, or alternatively, the T3 time period) as part of its UE capability reporting. The UE capability reporting in this context may be based on when or whether the LP-WUS frequency resource(s) are within the active BWP being used for the PDCCH monitoring that the LP-WUS triggers.

In some cases, the UE may also report its minimum necessary time gap for T1′ (and, additionally, or alternatively, the T3′ time period) as part of its UE capability reporting. These indication(s) may be based on when or whether the LP-WUS frequency resource(s) are outside of the active BWP being used for the PDCCH monitoring that the LP-WUS triggers. That is, the capability report may indicate a first defined time gap when the LP-WUS frequency resource(s) are within the active BWP and, additionally, or alternatively, a second defined time gap when the LP-WUS frequency resource(s) are outside of the active BWP. The value(s) of T1′ (and potentially T3′) may be based on when the LP-WUS frequency resources are outside the active BWP used for PDCCH monitoring that the LP-WUS triggers. These values may be different from the value(s) of T1 (and potentially T3) when the LP-WUS frequency resource(s) are within the active BWP used for PDCCH monitoring that the LP-WUS triggers. If the UE does not report the value(s) of T1′ (and potentially T3′) when the LP-WUS frequency resources are outside the active BWP used for PDCCH monitoring that the LP-WUS triggers, the value(s) of T1′ (and potentially T3′) when the LP-WUS frequency resources are outside of the active BWP may be the same as the values of T1 (and potentially T3) when the LP-WUS frequency resource(s) are within the active BWP.

In some cases, the UE may also report its minimum necessary time gap for T1′ (and, additionally, or alternatively, the T3′ time period) as part of its UE capability reporting. These indication(s) may be based on when or whether the LP-WUS frequency resource(s) are outside of the active BWP being used for the PDCCH monitoring that the LP-WUS triggers. That is, the capability report may indicate a first defined time gap when the LP-WUS frequency resources are within the active BWP and an offset value relative to the first defined time gap when the LP-WUS frequency resources are outside of the active BWP. When the LP-WUS frequency resources are outside of the active BWP, the minimum necessary time gap T1′ may correspond to the above-reported T1 time period plus the offset X. Similarly, the T3′ may correspond to the above-reported T3 time period plus the offset X. In this aspect, the offset X may be the active BWP switch delay based on the DCI or a timer that are specified for the UE. For example, the BWP switch delay may correspond to or be based on Table 1 above.

FIG. 4 illustrates an example where the frequency resource(s) of the LP-WUS are outside the active BWP being used for the PDCCH monitoring. Accordingly, this may include the UE using the first radio (e.g., the LR) to monitor for LP-WUS transmissions during the LP-WUS monitoring occasion 405-a and the LP-WUS monitoring occasion 405-b. In this example, the LP-WUS monitoring occasion 405-b may carry or otherwise convey an indication or information that triggers PDCCH monitoring for the UE using the second radio (e.g., the MR). Accordingly, the UE may perform PDCCH monitoring during the PDCCH monitoring period 410 according to the LP-WUS monitoring occasion 405-b being a triggering LP-WUS.

The UE may skip monitoring for additional LP-WUS transmission(s) at least during LP-WUS monitoring occasions that overlap in the time domain with the PDCCH monitoring period 410. The UE may skip monitoring for additional LP-WUS transmissions during the LP-WUS monitoring occasion 405-c that overlaps in the time domain with the PDCCH monitoring period 410 (e.g., corresponding to the T2 time period). Additionally, or alternatively, this may include the UE skipping monitoring for additional LP-WUS transmissions during the T1 time period that includes LP-WUS monitoring occasions that occur between the LP-WUS monitoring occasion 405-b and the beginning of the PDCCH monitoring period 410 where the UE monitors the PDCCH. Additionally, or alternatively, this may include the UE skipping monitoring for additional LP-WUS transmissions during the T3 time period that includes LP-WUS monitoring occasions that occur after the PDCCH monitoring period 410 and before a start or beginning of a next or subsequent LP-WUS monitoring occasion 405.

This may include the UE using the first radio (e.g., the LR) to monitor for LP-WUS transmissions during the LP-WUS monitoring occasion 405-d (e.g., the first LP-WUS monitoring occasion after the end of the T3 time period), during the LP-WUS monitoring occasion 405-e, during the LP-WUS monitoring occasion 405-f, and during the LP-WUS monitoring occasion 405-g. In this example, the LP-WUS monitoring occasion 405-g may carry or otherwise convey an indication or information that triggers PDCCH monitoring for the UE using the second radio (e.g., the MR). Accordingly, the UE may perform PDCCH monitoring during the PDCCH monitoring period 415 according to the LP-WUS monitoring occasion 405-g being a triggering LP-WUS. The UE may skip monitoring for additional LP-WUS transmission(s) at least during LP-WUS monitoring occasions that overlap in the time domain with the PDCCH monitoring period 415. The UE may skip monitoring for additional LP-WUS transmissions during the LP-WUS monitoring occasion 405-h that overlaps in the time domain with the PDCCH monitoring period 415 (e.g., corresponding to the T2 time period). Additionally, or alternatively, this may include the UE skipping monitoring for additional LP-WUS transmissions during the T1 time period that includes LP-WUS monitoring occasions that occur between the LP-WUS monitoring occasion 405-g and the beginning of the PDCCH monitoring period 415 where the UE monitors the PDCCH. Additionally, or alternatively, this may include the UE skipping monitoring for additional LP-WUS transmissions during the T3 time period that includes LP-WUS monitoring occasions that occur after the PDCCH monitoring period 415 and before a start or beginning of a next or subsequent LP-WUS monitoring occasion 405. In this example, this may include the UE monitoring for additional LP-WUS transmissions during the LP-WUS monitoring occasion 405-i (e.g., after the T3 time period).

As the LP-WUS frequency resources are outside the active BWP being used for the PDCCH monitoring, the duration of the T1 time period (and potentially the T3 time period) may be longer relative to when the LP-WUS frequency resources are outside of the active BWP.

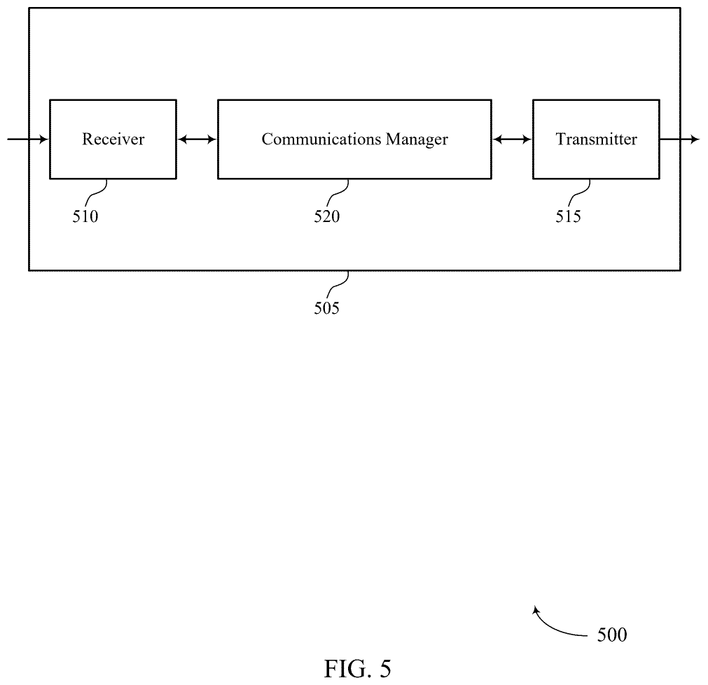

FIG. 5 shows a block diagram 500 of a device 505 that supports LP-WUS time gap in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to LP-WUS time gap). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to LP-WUS time gap). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of LP-WUS time gap as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving, using a first radio of the UE, a LP-WUS that triggers PDCCH monitoring using a second radio of the UE during a PDCCH monitoring period, where the LP-WUS is associated with a set of periodic LP-WUS transmissions scheduled during a corresponding set of periodic LP-WUS monitoring occasions. The communications manager 520 is capable of, configured to, or operable to support a means for performing, using the second radio of the UE, the PDCCH monitoring during the PDCCH monitoring period based on the LP-WUS, where monitoring for one or more additional LP-WUS transmissions during one or more other LP-WUS monitoring occasions in the corresponding set of periodic LP-WUS monitoring occasions that overlap in time with at least the PDCCH monitoring period is skipped.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for improved LP-WUS transmission monitoring and the corresponding LP-WUS triggered PDCCH monitoring by UE. This may include efficient operations where the UE does not use the LR to monitor for LP-WUS transmissions during a T1 time period before the PDCCH monitoring, a T2 time period during the PDCCH monitoring, and/or a T3 time period monitoring after the PDCCH monitoring. This may include UE capability reporting for the T1/T2/T3 time period(s) as well as capability reporting based on whether the LP-WUS frequency resources are within or outside of the active BWP being used for the PDCCH monitoring.

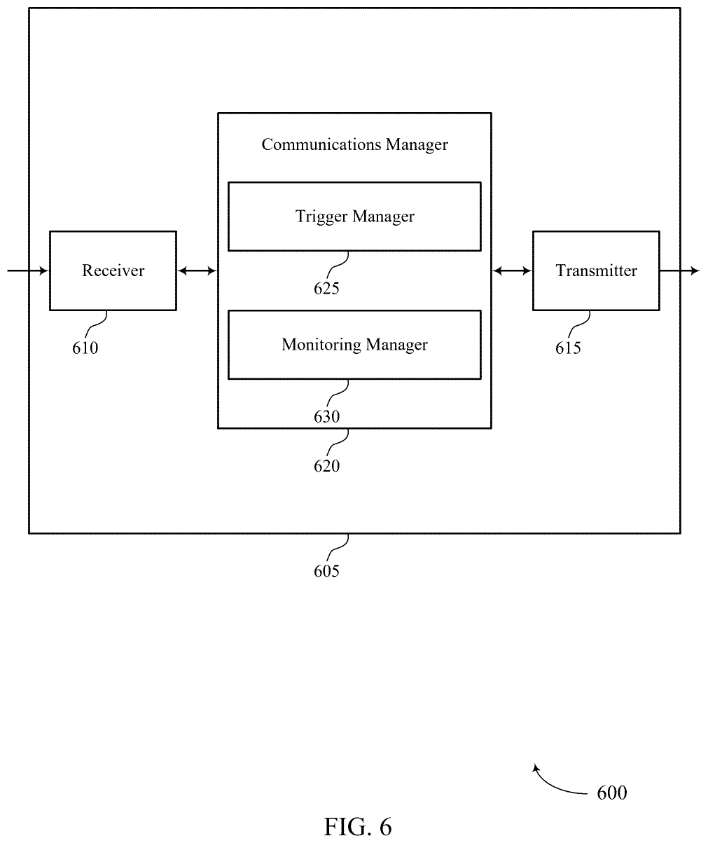

FIG. 6 shows a block diagram 600 of a device 605 that supports LP-WUS time gap in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to LP-WUS time gap). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to LP-WUS time gap). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of LP-WUS time gap as described herein. For example, the communications manager 620 may include a trigger manager 625 a monitoring manager 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The trigger manager 625 is capable of, configured to, or operable to support a means for receiving, using a first radio of the UE, a LP-WUS that triggers PDCCH monitoring using a second radio of the UE during a PDCCH monitoring period, where the LP-WUS is associated with a set of periodic LP-WUS transmissions scheduled during a corresponding set of periodic LP-WUS monitoring occasions. The monitoring manager 630 is capable of, configured to, or operable to support a means for performing, using the second radio of the UE, the PDCCH monitoring during the PDCCH monitoring period based on the LP-WUS, where monitoring for one or more additional LP-WUS transmissions during one or more other LP-WUS monitoring occasions in the corresponding set of periodic LP-WUS monitoring occasions that overlap in time with at least the PDCCH monitoring period is skipped.

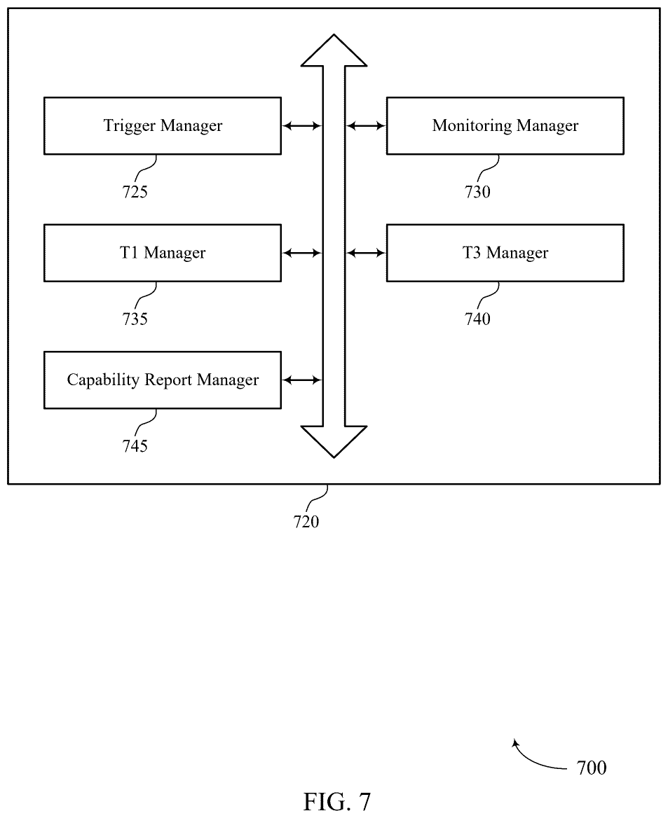

FIG. 7 shows a block diagram 700 of a communications manager 720 that supports LP-WUS time gap in accordance with one or more aspects of the present disclosure. The communications manager 720 may be an example of aspects of a communications manager 520, a communications manager 620, or both, as described herein. The communications manager 720, or various components thereof, may be an example of means for performing various aspects of LP-WUS time gap as described herein. For example, the communications manager 720 may include a trigger manager 725, a monitoring manager 730, a T1 manager 735, a T3 manager 740, a capability report manager 745, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The trigger manager 725 is capable of, configured to, or operable to support a means for receiving, using a first radio of the UE, a LP-WUS that triggers PDCCH monitoring using a second radio of the UE during a PDCCH monitoring period, where the LP-WUS is associated with a set of periodic LP-WUS transmissions scheduled during a corresponding set of periodic LP-WUS monitoring occasions. The monitoring manager 730 is capable of, configured to, or operable to support a means for performing, using the second radio of the UE, the PDCCH monitoring during the PDCCH monitoring period based on the LP-WUS, where monitoring for one or more additional LP-WUS transmissions during one or more other LP-WUS monitoring occasions in the corresponding set of periodic LP-WUS monitoring occasions that overlap in time with at least the PDCCH monitoring period is skipped. In some examples, the one or more other LP-WUS monitoring occasions correspond to the PDCCH monitoring period.

In some examples, the T1 manager 735 is capable of, configured to, or operable to support a means for skipping monitoring for one or more additional LP-WUS transmissions during one or more LP-WUS monitoring occasions in the corresponding set of periodic LP-WUS monitoring occasions that overlap in time with a time period before the PDCCH monitoring period. In some examples, the time period corresponds to a time gap between the LP-WUS transmission triggering the PDCCH monitoring and the PDCCH monitoring period. In some examples, the time period is a same time period as a time gap between the PDCCH monitoring period and a start of a LP-WUS monitoring occasion after the PDCCH monitoring period.

In some examples, the T3 manager 740 is capable of, configured to, or operable to support a means for skipping monitoring for one or more additional LP-WUS transmissions during one or more LP-WUS monitoring occasions in the corresponding set of periodic LP-WUS monitoring occasions that overlap in time with a time period following the PDCCH monitoring period. In some examples, the time period corresponds to a time gap between the PDCCH monitoring period and a start of a LP-WUS monitoring occasion after the PDCCH monitoring period. In some examples, the time period is a same time period as a time gap between the LP-WUS transmission triggering the PDCCH monitoring and the PDCCH monitoring period.

In some examples, the capability report manager 745 is capable of, configured to, or operable to support a means for transmitting a capability report indicating a defined time gap that corresponds to a time gap between the LP-WUS transmission triggering the PDCCH monitoring and the PDCCH monitoring period, where the defined time gap is based on whether LP-WUS frequency resources of the set of periodic LP-WUS transmissions overlap in frequency with an active bandwidth part associated with PDCCH monitoring frequency resources. In some examples, the capability report indicates a first defined time gap when the LP-WUS frequency resources are within the active bandwidth part, a second defined time gap when the LP-WUS frequency resources are outside of the active bandwidth part, or both. In some examples, the capability report indicates a first defined time gap when the LP-WUS frequency resources are within the active bandwidth part and an offset value relative to the first defined time gap when the LP-WUS frequency resources are outside of the active bandwidth part.

In some examples, the capability report manager 745 is capable of, configured to, or operable to support a means for transmitting a capability report indicating a defined time gap that corresponds to a time gap between the PDCCH monitoring period and a start of a LP-WUS monitoring occasion after the PDCCH monitoring period, where the defined time gap is based on whether LP-WUS frequency resources of the set of periodic LP-WUS transmissions overlap in frequency with an active bandwidth part associated with PDCCH monitoring frequency resources. In some examples, the capability report indicates a first defined time gap when the LP-WUS frequency resources are within the active bandwidth part, a second defined time gap when the LP-WUS frequency resources are outside of the active bandwidth part, or both. In some examples, the capability report indicates a first defined time gap when the LP-WUS frequency resources are within the active bandwidth part and an offset value relative to the first defined time gap when the LP-WUS frequency resources are outside of the active bandwidth part.

In some examples, the first radio includes a LR of the UE and the second radio includes a MR of the UE.

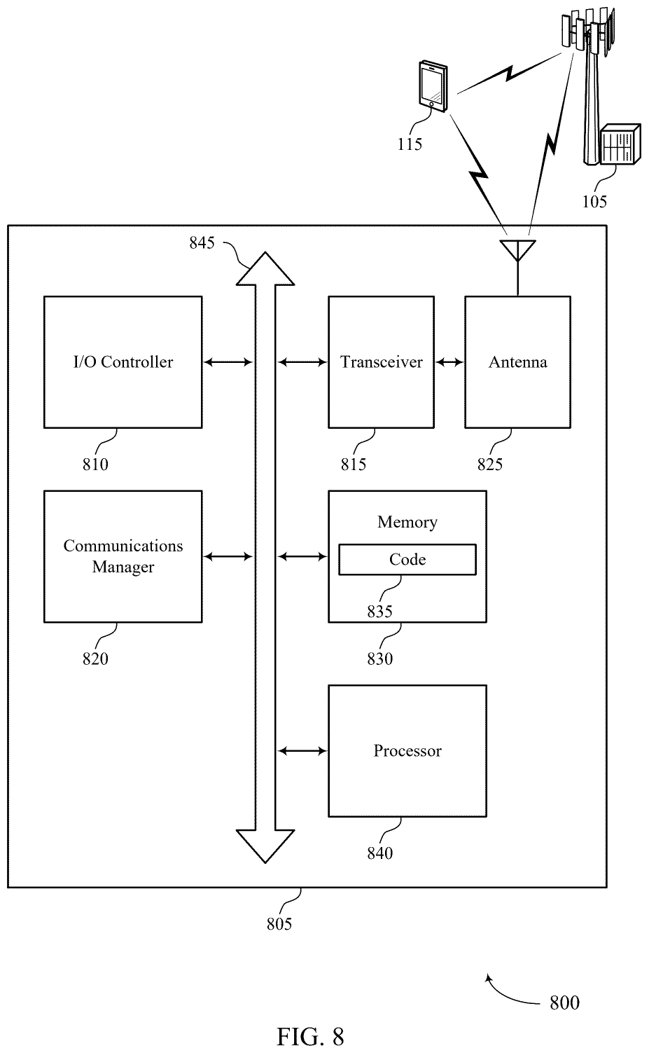

FIG. 8 shows a diagram of a system 800 including a device 805 that supports LP-WUS time gap in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting LP-WUS time gap). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving, using a first radio of the UE, a LP-WUS that triggers PDCCH monitoring using a second radio of the UE during a PDCCH monitoring period, where the LP-WUS is associated with a set of periodic LP-WUS transmissions scheduled during a corresponding set of periodic LP-WUS monitoring occasions. The communications manager 820 is capable of, configured to, or operable to support a means for performing, using the second radio of the UE, the PDCCH monitoring during the PDCCH monitoring period based on the LP-WUS, where monitoring for one or more additional LP-WUS transmissions during one or more other LP-WUS monitoring occasions in the corresponding set of periodic LP-WUS monitoring occasions that overlap in time with at least the PDCCH monitoring period is skipped.

By including or configuring the communications manager 820 in accordance with examples as described herein, the device 805 may support techniques for improved LP-WUS transmission monitoring and the corresponding LP-WUS triggered PDCCH monitoring by UE. This may include efficient operations where the UE does not use the LR to monitor for LP-WUS transmissions during a T1 time period before the PDCCH monitoring, a T2 time period during the PDCCH monitoring, and/or a T3 time period monitoring after the PDCCH monitoring. This may include UE capability reporting for the T1/T2/T3 time period(s) as well as capability reporting based on whether the LP-WUS frequency resources are within or outside of the active BWP being used for the PDCCH monitoring.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of LP-WUS time gap as described herein, or the at least one processor 840 and the at least one memory 830 may be otherwise configured to, individually or collectively, perform or support such operations.

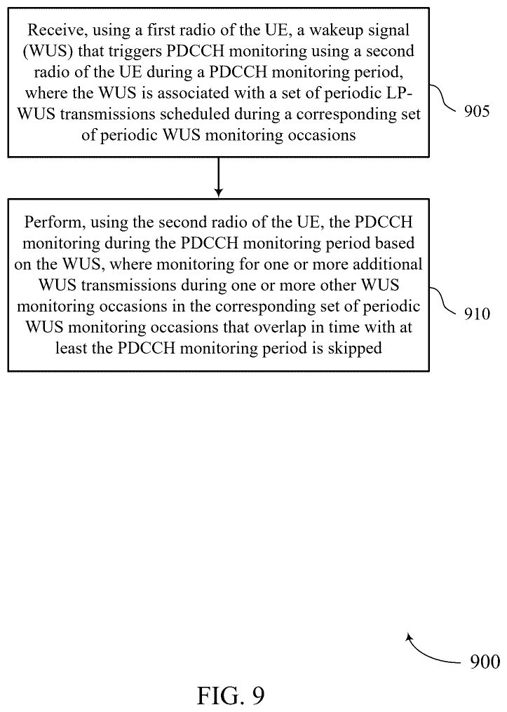

FIG. 9 shows a flowchart illustrating a method 900 that supports LP-WUS time gap in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving, using a first radio of the UE, a LP-WUS that triggers PDCCH monitoring using a second radio of the UE during a PDCCH monitoring period, where the LP-WUS is associated with a set of periodic LP-WUS transmissions scheduled during a corresponding set of periodic LP-WUS monitoring occasions. The operations of 905 may be performed in accordance with examples as disclosed herein. In some examples, aspects of the operations of 905 may be performed by a trigger manager 725 as described with reference to FIG. 7.

At 910, the method may include performing, using the second radio of the UE, the PDCCH monitoring during the PDCCH monitoring period based on the LP-WUS, where monitoring for one or more additional LP-WUS transmissions during one or more other LP-WUS monitoring occasions in the corresponding set of periodic LP-WUS monitoring occasions that overlap in time with at least the PDCCH monitoring period is skipped. The operations of 910 may be performed in accordance with examples as disclosed herein. In some examples, aspects of the operations of 910 may be performed by a monitoring manager 730 as described with reference to FIG. 7.

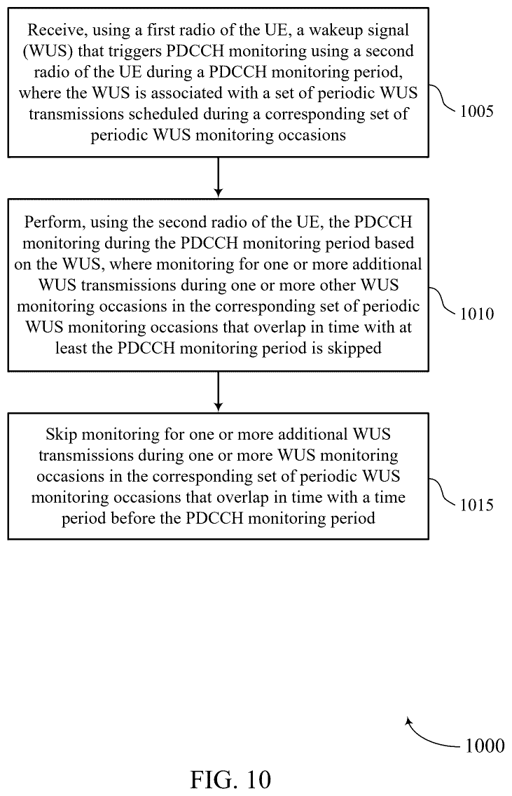

FIG. 10 shows a flowchart illustrating a method 1000 that supports LP-WUS time gap in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include receiving, using a first radio of the UE, a LP-WUS that triggers PDCCH monitoring using a second radio of the UE during a PDCCH monitoring period, where the LP-WUS is associated with a set of periodic LP-WUS transmissions scheduled during a corresponding set of periodic LP-WUS monitoring occasions. The operations of 1005 may be performed in accordance with examples as disclosed herein. In some examples, aspects of the operations of 1005 may be performed by a trigger manager 725 as described with reference to FIG. 7.

At 1010, the method may include performing, using the second radio of the UE, the PDCCH monitoring during the PDCCH monitoring period based on the LP-WUS, where monitoring for one or more additional LP-WUS transmissions during one or more other LP-WUS monitoring occasions in the corresponding set of periodic LP-WUS monitoring occasions that overlap in time with at least the PDCCH monitoring period is skipped. The operations of 1010 may be performed in accordance with examples as disclosed herein. In some examples, aspects of the operations of 1010 may be performed by a monitoring manager 730 as described with reference to FIG. 7.

At 1015, the method may include skipping monitoring for one or more additional LP-WUS transmissions during one or more LP-WUS monitoring occasions in the corresponding set of periodic LP-WUS monitoring occasions that overlap in time with a time period before the PDCCH monitoring period. The operations of 1015 may be performed in accordance with examples as disclosed herein. In some examples, aspects of the operations of 1015 may be performed by a T1 manager 735 as described with reference to FIG. 7.

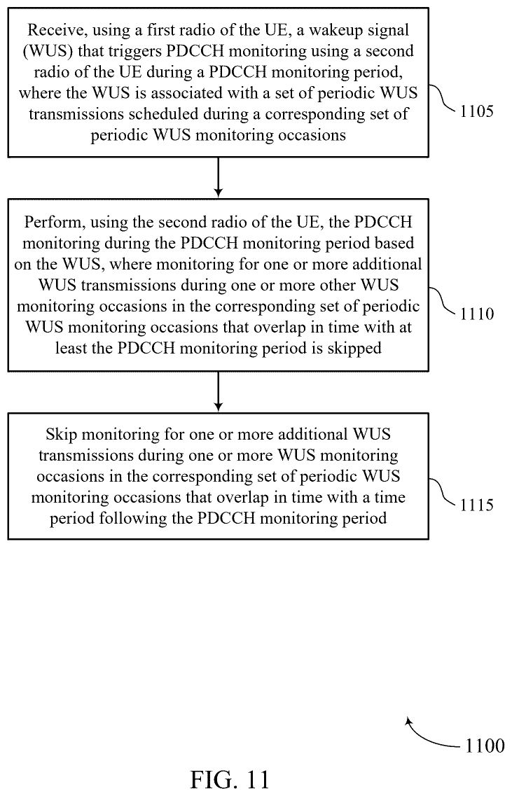

FIG. 11 shows a flowchart illustrating a method 1100 that supports LP-WUS time gap in accordance with one or more aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include receiving, using a first radio of the UE, a LP-WUS that triggers PDCCH monitoring using a second radio of the UE during a PDCCH monitoring period, where the LP-WUS is associated with a set of periodic LP-WUS transmissions scheduled during a corresponding set of periodic LP-WUS monitoring occasions. The operations of 1105 may be performed in accordance with examples as disclosed herein. In some examples, aspects of the operations of 1105 may be performed by a trigger manager 725 as described with reference to FIG. 7.

At 1110, the method may include performing, using the second radio of the UE, the PDCCH monitoring during the PDCCH monitoring period based on the LP-WUS, where monitoring for one or more additional LP-WUS transmissions during one or more other LP-WUS monitoring occasions in the corresponding set of periodic LP-WUS monitoring occasions that overlap in time with at least the PDCCH monitoring period is skipped. The operations of 1110 may be performed in accordance with examples as disclosed herein. In some examples, aspects of the operations of 1110 may be performed by a monitoring manager 730 as described with reference to FIG. 7.

At 1115, the method may include skipping monitoring for one or more additional LP-WUS transmissions during one or more LP-WUS monitoring occasions in the corresponding set of periodic LP-WUS monitoring occasions that overlap in time with a time period following the PDCCH monitoring period. The operations of 1115 may be performed in accordance with examples as disclosed herein. In some examples, aspects of the operations of 1115 may be performed by a T3 manager 740 as described with reference to FIG. 7.

The following provides an overview of aspects of the present disclosure:

Aspect 1: A method for wireless communications at a UE, comprising: receiving, using a first radio of the UE, a WUS that triggers PDCCH monitoring using a second radio of the UE during a PDCCH monitoring period, wherein the WUS is associated with a set of periodic WUS transmissions scheduled during a corresponding set of periodic WUS monitoring occasions; and performing, using the second radio of the UE, the PDCCH monitoring during the PDCCH monitoring period based at least in part on the WUS, wherein monitoring for one or more additional WUS transmissions during one or more other WUS monitoring occasions in the corresponding set of periodic WUS monitoring occasions that overlap in time with at least the PDCCH monitoring period is skipped.

Aspect 2: The method of aspect 1, wherein the one or more other WUS monitoring occasions correspond to the PDCCH monitoring period.

Aspect 3: The method of any of aspects 1 through 2, further comprising: skipping monitoring for one or more additional WUS transmissions during one or more WUS monitoring occasions in the corresponding set of periodic WUS monitoring occasions that overlap in time with a time period before the PDCCH monitoring period.

Aspect 4: The method of aspect 3, wherein the time period corresponds to a time gap between the WUS transmission triggering the PDCCH monitoring and the PDCCH monitoring period.

Aspect 5: The method of any of aspects 3 through 4, wherein the time period is a same time period as a time gap between the PDCCH monitoring period and a start of a WUS monitoring occasion after the PDCCH monitoring period.

Aspect 6: The method of any of aspects 1 through 5, further comprising: skipping monitoring for one or more additional WUS transmissions during one or more WUS monitoring occasions in the corresponding set of periodic WUS monitoring occasions that overlap in time with a time period following the PDCCH monitoring period.

Aspect 7: The method of aspect 6, wherein the time period corresponds to a time gap between the PDCCH monitoring period and a start of a WUS monitoring occasion after the PDCCH monitoring period.

Aspect 8: The method of any of aspects 6 through 7, wherein the time period is a same time period as a time gap between the WUS transmission triggering the PDCCH monitoring and the PDCCH monitoring period.

Aspect 9: The method of any of aspects 1 through 8, further comprising: transmitting a capability report indicating a defined time gap that corresponds to a time gap between the WUS transmission triggering the PDCCH monitoring and the PDCCH monitoring period, wherein the defined time gap is based on whether WUS frequency resources of the set of periodic WUS transmissions overlap in frequency with an active bandwidth part associated with PDCCH monitoring frequency resources.

Aspect 10: The method of aspect 9, wherein the capability report indicates a first defined time gap when the WUS frequency resources are within the active bandwidth part, a second defined time gap when the WUS frequency resources are outside of the active bandwidth part, or both.

Aspect 11: The method of any of aspects 9 through 10, wherein the capability report indicates a first defined time gap when the WUS frequency resources are within the active bandwidth part and an offset value relative to the first defined time gap when the WUS frequency resources are outside of the active bandwidth part.

Aspect 12: The method of any of aspects 1 through 11, further comprising: transmitting a capability report indicating a defined time gap that corresponds to a time gap between the PDCCH monitoring period and a start of a WUS monitoring occasion after the PDCCH monitoring period, wherein the defined time gap is based on whether WUS frequency resources of the set of periodic WUS transmissions overlap in frequency with an active bandwidth part associated with PDCCH monitoring frequency resources.

Aspect 13: The method of aspect 12, wherein the capability report indicates a first defined time gap when the WUS frequency resources are within the active bandwidth part, a second defined time gap when the WUS frequency resources are outside of the active bandwidth part, or both.

Aspect 14: The method of any of aspects 12 through 13, wherein the capability report indicates a first defined time gap when the WUS frequency resources are within the active bandwidth part and an offset value relative to the first defined time gap when the WUS frequency resources are outside of the active bandwidth part.

Aspect 15: The method of any of aspects 1 through 14, wherein the first radio comprises a low-power radio of the UE and the second radio comprises a main radio of the UE.

Aspect 16: A UE for wireless communications, comprising one or more memories storing processor-executable code, and one or more processors coupled with the one or more memories and individually or collectively operable to execute the code to cause the UE to perform a method of any of aspects 1 through 15.

Aspect 17: A UE for wireless communications, comprising at least one means for performing a method of any of aspects 1 through 15.

Aspect 18: A non-transitory computer-readable medium storing code for wireless communications, the code comprising instructions executable by one or more processors to perform a method of any of aspects 1 through 15.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, using a first radio of the UE, a wakeup signal (WUS) that triggers physical downlink control channel (PDCCH) monitoring using a second radio of the UE during a PDCCH monitoring period, wherein the WUS is associated with a set of periodic WUS transmissions scheduled during a corresponding set of periodic WUS monitoring occasions; and
perform, using the second radio of the UE, the PDCCH monitoring during the PDCCH monitoring period based at least in part on the WUS, wherein monitoring for one or more additional WUS transmissions during one or more other WUS monitoring occasions in the corresponding set of periodic WUS monitoring occasions that overlap in time with at least the PDCCH monitoring period is skipped.

2. The UE of claim 1, wherein the one or more other WUS monitoring occasions correspond to the PDCCH monitoring period.

3. The UE of claim 1, wherein the one or more processors are individually or collectively further operable to execute the code to cause the UE to:
skip monitoring for one or more additional WUS transmissions during one or more WUS monitoring occasions in the corresponding set of periodic WUS monitoring occasions that overlap in time with a time period before the PDCCH monitoring period.

4. The UE of claim 3, wherein the time period corresponds to a time gap between the WUS transmission triggering the PDCCH monitoring and the PDCCH monitoring period.

5. The UE of claim 3, wherein the time period is a same time period as a time gap between the PDCCH monitoring period and a start of a WUS monitoring occasion after the PDCCH monitoring period.

6. The UE of claim 1, wherein the one or more processors are individually or collectively further operable to execute the code to cause the UE to:
skip monitoring for one or more additional WUS transmissions during one or more WUS monitoring occasions in the corresponding set of periodic WUS monitoring occasions that overlap in time with a time period following the PDCCH monitoring period.

7. The UE of claim 6, wherein the time period corresponds to a time gap between the PDCCH monitoring period and a start of a WUS monitoring occasion after the PDCCH monitoring period.

8. The UE of claim 6, wherein the time period is a same time period as a time gap between the WUS transmission triggering the PDCCH monitoring and the PDCCH monitoring period.

9. The UE of claim 1, wherein the one or more processors are individually or collectively further operable to execute the code to cause the UE to:
transmit a capability report indicating a defined time gap that corresponds to a time gap between the WUS transmission triggering the PDCCH monitoring and the PDCCH monitoring period, wherein the defined time gap is based on whether WUS frequency resources of the set of periodic WUS transmissions overlap in frequency with an active bandwidth part associated with PDCCH monitoring frequency resources.

10. The UE of claim 9, wherein the capability report indicates a first defined time gap when the WUS frequency resources are within the active bandwidth part, a second defined time gap when the WUS frequency resources are outside of the active bandwidth part, or both.

11. The UE of claim 9, wherein the capability report indicates a first defined time gap when the WUS frequency resources are within the active bandwidth part and an offset value relative to the first defined time gap when the WUS frequency resources are outside of the active bandwidth part.

12. The UE of claim 1, wherein the one or more processors are individually or collectively further operable to execute the code to cause the UE to:
transmit a capability report indicating a defined time gap that corresponds to a time gap between the PDCCH monitoring period and a start of a WUS monitoring occasion after the PDCCH monitoring period, wherein the defined time gap is based on whether WUS frequency resources of the set of periodic WUS transmissions overlap in frequency with an active bandwidth part associated with PDCCH monitoring frequency resources.

13. The UE of claim 12, wherein the capability report indicates a first defined time gap when the WUS frequency resources are within the active bandwidth part, a second defined time gap when the WUS frequency resources are outside of the active bandwidth part, or both.

14. The UE of claim 12, wherein the capability report indicates a first defined time gap when the WUS frequency resources are within the active bandwidth part and an offset value relative to the first defined time gap when the WUS frequency resources are outside of the active bandwidth part.

15. The UE of claim 1, wherein the first radio comprises a low-power radio of the UE and the second radio comprises a main radio of the UE.

16. A method for wireless communications at a user equipment (UE), comprising:
receiving, using a first radio of the UE, a wakeup signal (WUS) that triggers physical downlink control channel (PDCCH) monitoring using a second radio of the UE during a PDCCH monitoring period, wherein the WUS is associated with a set of periodic WUS transmissions scheduled during a corresponding set of periodic WUS monitoring occasions; and
performing, using the second radio of the UE, the PDCCH monitoring during the PDCCH monitoring period based at least in part on the WUS, wherein monitoring for one or more additional WUS transmissions during one or more other WUS monitoring occasions in the corresponding set of periodic WUS monitoring occasions that overlap in time with at least the PDCCH monitoring period is skipped.

17. The method of claim 16, wherein the one or more other WUS monitoring occasions correspond to the PDCCH monitoring period.

18. The method of claim 16, further comprising:
skipping monitoring for one or more additional WUS transmissions during one or more WUS monitoring occasions in the corresponding set of periodic WUS monitoring occasions that overlap in time with a time period before the PDCCH monitoring period.

19. The method of claim 18, wherein the time period corresponds to a time gap between the WUS transmission triggering the PDCCH monitoring and the PDCCH monitoring period.

20. A non-transitory computer-readable medium storing code for wireless communications, the code comprising instructions executable by one or more processors to:
receive, using a first radio of a user equipment (UE), a wakeup signal (WUS) that triggers physical downlink control channel (PDCCH) monitoring using a second radio of the UE during a PDCCH monitoring period, wherein the WUS is associated with a set of periodic WUS transmissions scheduled during a corresponding set of periodic WUS monitoring occasions; and
perform, using the second radio of the UE, the PDCCH monitoring during the PDCCH monitoring period based at least in part on the WUS, wherein monitoring for one or more additional WUS transmissions during one or more other WUS monitoring occasions in the corresponding set of periodic WUS monitoring occasions that overlap in time with at least the PDCCH monitoring period is skipped.
